(19) United States
(12) Patent Application Publication
(10) Pub. No.: US 2011/0085766 A1
(43) Pub. Date: Apr. 14, 2011

(54) OPTICAL CONNECTOR WITH IMPROVED POSITION MECHANISM FOR HOLDING AN OPTICAL MODULE THEREOF

(75) Inventors: CHI-NAN LIAO, Tu-Cheng (TW); JIA-YONG HE, Kunshan (CN); QI-SHENG ZHENG, Kunshan (CN); HSIEN-CHU LIN, Tu-Cheng (TW); YU-HUNG YEN, Tu-Cheng (TW)

(73) Assignee: HON HAI PRECISION INDUSTRY CO., LTD., Tu-Cheng (TW)

(21) Appl. No.: 12/900,485

(22) Filed: Oct. 8, 2010

(30) Foreign Application Priority Data
Oct. 9, 2009 (TW) 98218731
Oct. 16, 2009 (CN) 200910308390.8

(51) Int. Cl. G02B 6/38

(52) U.S. Cl. 385/71

(57) ABSTRACT

An optical connector includes an insultive housing, and an optical module disposed on the insulative housing. The insulative housing has a top surface, a bottom surface, a cavity and a number of slim slots recessed from the bottom surface. The slim slots extend along a front to back direction and located behind the cavity. The optical module has a base received in the cavity and a number of fibers retained on the base and extending along a front to back direction. Each fiber has a coupling portion retained in the base, a positioning portion behind the coupling portion, and a connecting portion backwardly extending out of the insulative housing. The positioning portions are respectively positioned in the slim slots for holding the base to prevent the base from overly moving along a transverse direction.

### BACKGROUND OF THE INVENTION

1. Field of the Invention

The present invention relates to an optical connector, and more particularly to optical connectors with improved position mechanism for holding an optical module thereof.

2. Description of Related Art

Universal Serial Bus (USB) is widely used in variety electric devices as a standard and simple interface. Until now, USB specification has went through 0.9, 1.0, 1.1, 2.0 and 3.0 versions. Speed data rate of USB connector is gradually increased at the same time for adapting the rapid development of electric industry. Recently, designers further design a new connector which is added optical fibers to USB 3.0 for supplying an even higher data rate than USB 3.0 and achieving remote signal transmission. The new connector is an optical connector, and comprises an insulative housing, USB 3.0 contacts retained on the insulative housing and an optical module received in the insulative housing to transmit optical signal. Therefore, the optical connector is based on USB interface and can mate with a USB connector. The optical module has a lens and a plurality of fibers partly received in the lens. The fibers extend out of a rear end of lens to connect with a cable behind the optical connector. The insulative housing defines a receiving cavity to receive the optical module. And the optical module can move in the receiving cavity along an insertion direction of a mating connector. In a mating process of the mating connector, the optical module can be resisted backwardly and shakes along a transverse direction until the mating connector exactly connect with the optical connector.

However, when the optical module moves overly, the optical module would be inclined and can not exactly connect with the mating connector along the insertion direction; besides, the fibers is straightly connected with the cables behind the optical connector, thereby the overly movement of the optical module can easily break the fibers.

Hence, an improved optical connector is desired to overcome the above problems.

### BRIEF SUMMARY OF THE INVENTION

According to the present invention, an optical connector comprises: an insultive housing having a top surface, a bottom surface, a cavity and a plurality of slim slots recessed from the bottom surface, the slim slots extending along a front to back direction and located behind the cavity; an optical module disposed on the insulative housing, the optical module having a base received in the cavity and a plurality of fibers retained on the base and extending along a front to back direction; wherein each fiber has a coupling portion retained in the base, a positioning portion behind the coupling portion, and a connecting portion backwardly extending out of the insulative housing, the positioning portions are respectively positioned in the slim slots for holding the base to prevent the base from overly moving along a transverse direction.

According to another aspect of the present invention, an optical connector comprises: an insulative housing having a body portion and a tongue extending forwardly, the insulative housing defining a cavity recessed from a lower side of the tongue and a plurality of slim slots behind the cavity; a plurality of contacts retained on the insulative housing, each contact having a contact portion forwardly extending to an upper side of the tongue; and an optical module having a base movably received in the cavity and a plurality of fibers retained on the base, each fiber having a coupling portion retained in the base and a positioning portion backwardly extending out of the base to be positioned in the slim slots.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an optical connector according to a first embodiment of the present invention;

FIG. 2 is a partly exploded view of the optical connector shown in FIG. 1 with a cable removed;

FIG. 3 is a view similar to FIG. 2, while taken from another aspect;

FIG. 4 is a partly perspective view of the optical connector shown in FIG. 3 with a metal shell removed;

FIG. 5 is an exploded view of the optical connector shown in FIG. 4;

FIG. 6 is a view similar to FIG. 5, while taken from another aspect;

FIG. 7 is a partly perspective view of the optical connector according to a second embodiment of the present invention with a cable and a metal shell removed;

FIG. 8 is an exploded view of the optical connector shown in FIG. 7; and

FIG. 9 is a view similar to FIG. 8, while taken from another aspect.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

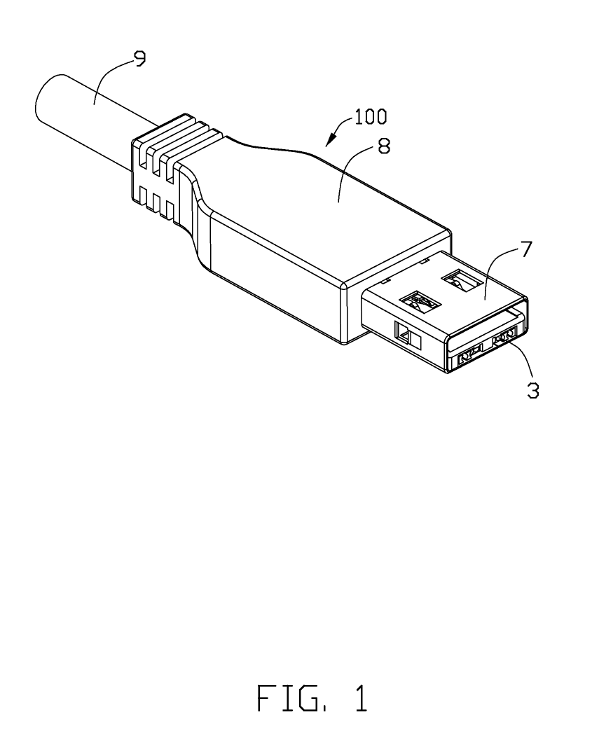

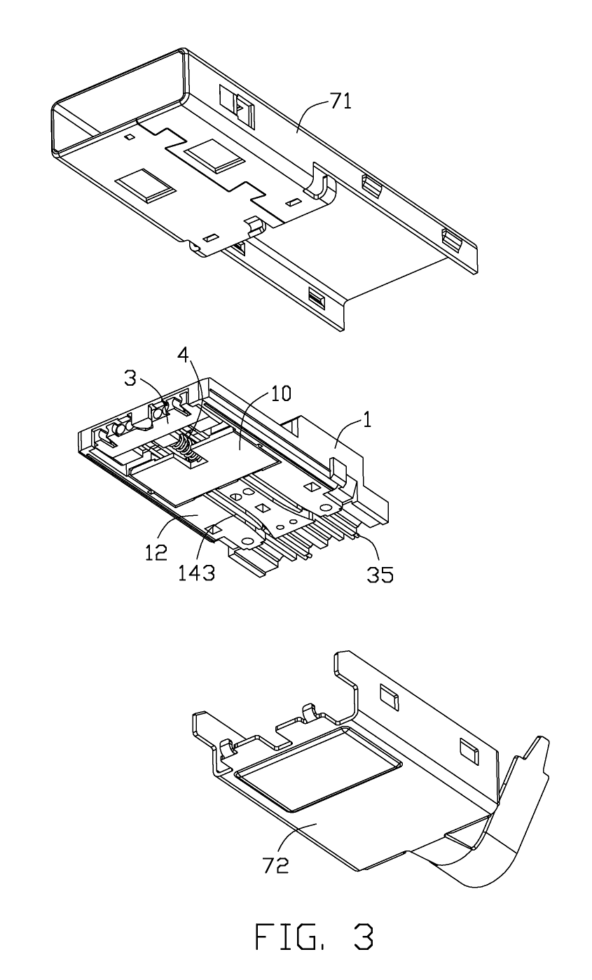

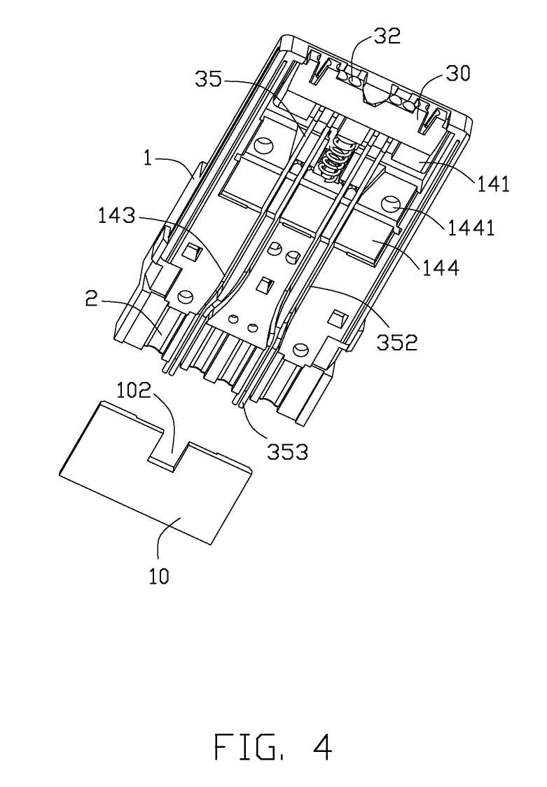

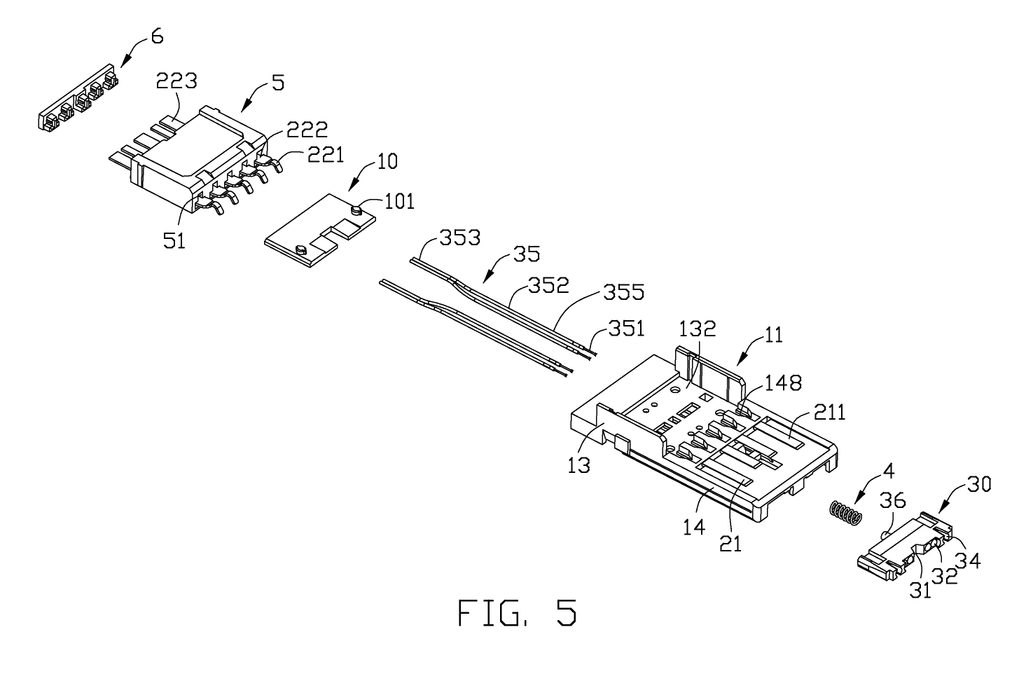

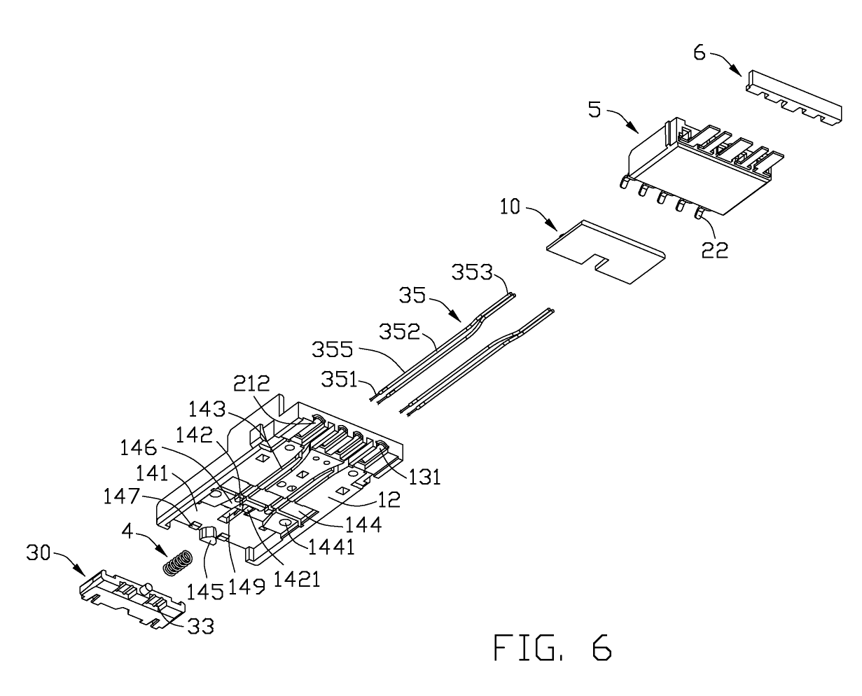

Referring to FIGS. 1-6, an optical connector 100 according to a first embodiment of the present invention is disclosed. The optical connector 100 is an optical and electrical plug connector, and comprises an insulative housing 1, a plurality of contacts 2 retained in the insulative housing 1, an optical module 3 disposed in the insulative housing 1, a spring 4 sandwiched between the optical module 3 and the insulative housing 1, an insulator 5 retained on the insulative housing 1, a spacer 6 fastened on a rear side of the insulator 5, a metal shell 7 covering the insulative housing 1, an outer case 8 covering the metal shell 7 and a cable 9 connecting a rear end of the contacts 2 and the optical module 3. The cable 9 has electrical cable and optical cable.

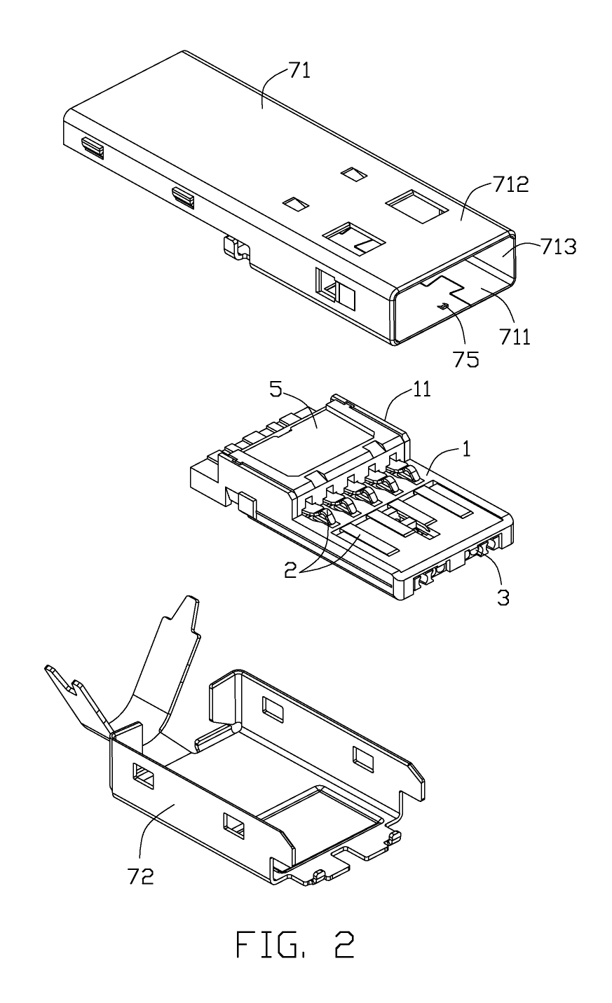

Referring to FIGS. 2-6, the insulative housing 1 has a top surface 11 and a bottom surface 12 respectively located at top and bottom side thereof. The insulative housing 1 has a body portion 13 and a tongue 14 forwardly extending from a front side of the body portion 13. The insulative housing 1 defines a plurality of first grooves 131 recessed from a rear side of the bottom surface 12 and a receiving space 132 recessed from the top surface 11. The insulator 5 is received in the receiving space 132.

The tongue 14 defines a cavity 141 recessed from a front side of the bottom surface 12, a floating recess 146 behind the cavity 141 and an cutout 142 further recessed from a middle position of a lower inner wall of the floating recess 146 along an up to down direction. The floating recess 146 communicates with the cavity 141 along a front to back direction perpendicular to the up to down direction. The insulative housing 1 further defines a plurality of slots 143 slimly extending along the front to back direction behind the floating recess 146. The slots 143 forwardly communicate with the floating recess 146, and backwardly extend through the insulative housing 1. A first positioning post 1421 forwardly extends into the cutout 142 from a rear inner wall of the cutout 142 and is located behind the cavity 141. A rear end of the spring 4 rings on the first positioning post 1421 and can swing in the opening 142 along the up to down direction. The tongue 14 defines an opening 149 extending therethrough at a rear position of the cavity 141. The opening 149 is located below a front end of the spring 4 for supplying a swing space to the front end of the spring 4.

The insulative housing 1 has a depression 144 recessed from the bottom surface 12. The depression 144 is located behind the cavity 141 and is more shallow than the cavity 141 along the up to down direction. The floating recess 146 is further recessed from a front and middle position of a top inner wall of the depression 144. The front sides of the slim slots 143 are further recessed from a rear side of the top inner wall of the depression 144. A pair of fastening holes 1441 is further recessed from two sides of the depression 144 to position a cover 10 into the depression 144. The cover 10 covers a lower side of the floating recess 146 and the slim slots 143, and is formed with a pair of fastening posts 101 to engage with the fastening holes 1441. Besides, the cover 10 defines an aperture 102 extending therethrough and aligns with the cutout 122 along the up to down direction, then the spring 4 can swing along the up to down direction. The tongue 14 is formed with a V-shaped limiting block 145 at a front side of the cavity 141, and a pair of embosses 147 at two sides of the limiting block 145. The tongue 14 defines a plurality of second grooves 148 recessed from a top side thereof and communicating with the receiving space 132 along the front to back direction.

An arrangement of the contacts 2 on the tongue 14 is compatible to USB 3.0 standard. The contacts 2 comprise a plurality of first contacts 21 and a plurality of second contacts 22. The first contacts 21 are insert-molded in the insulative housing 1. Each first contact 21 has a flat first contact portion 211 at front side of the second grooves 148, a first tail portion 212 received in the first grooves 131 to electrically connect with the cable 9. The second contacts 22 are retained on the insulator 5. Each second contact 22 has a second retaining portion 222 retained in the insulator 5, a flexible second contact portion 221 forwardly extending into the contact second grooves 148, and a second tail portion 223 backwardly extending from a rear end of the retaining portion 222 to electrically connect with the cable 9. All first contact portions 211 are arranged in a row along a transverse direction, and all second contact portions 221 are arranged in another row along the transverse direction behind the first contact portions 211. The first contact portions 211 and the second contact portions 221 are located at an upper side of the tongue 14. The optical module 3 is spaced apart from the first and second contact portions 211, 221 along the up to down direction.

The insulator 5 presents as a rectangular block. The insulator 5 defines a plurality of passageways 51 extending therethrough along the front to back direction to retain the second retaining portions 222. The spacer 6 protrudes into the passageways 51 to press the second retaining portions 222. The second retaining portions 222 can be alternatively insert-molded in the insulator 5.

Referring to FIGS. 2-6, the optical module 3 comprises a base 30 received in the cavity 141 and a plurality of fibers 35 attached to the base 30. The base 30 can move in the cavity 141 along the front to back direction. The base 30 defines a V-shaped indentation 31 recessed from a front end thereof to engage with the limiting block 145 for limiting a forward movement of the base 30. The base 30 is formed with two pairs of lenses 32 at a front side thereof, and two pairs of receiving holes 33 behind the lens 32 along the front to back direction respectively. Said two pairs of lenses 32 are respectively located at two outer sides of the V-shaped indentation 31. The slim slots 143 on the insulative housing 1 correspond with the receiving holes 33 along the front to back direction respectively. The base 30 further defines a pair of position holes 34 recessed from the front end thereof and located at two outer sides of all lenses 32 respectively. The position holes 34 are used to engage with a pair of posts on a corresponding mating connector (not shown) for aligning middle lines of the optical connector 100 and the mating connector, then the lenses 32 can exactly face to that on the mating connector for transmitting optical signals. The base 30 has a second positioning post 36 backwardly extending from a rear end thereof. A front end of the spring 4 rings on the second positioning post 36, then the spring 4 can be sandwiched between the first and second positioning posts 1421, 36 for forwardly resisting the base 30.

The optical connector 100 in the present invention has four fibers 35. Each fiber 35 has a coupling portion 351 positioned in the receiving holes 33 behind the lenses 32, a floating portion 355 backwardly extending from a rear end of the coupling portion 351, a positioning portion 352 backwardly extending from a rear end of the coupling portion 351 and a connecting portion 353 backwardly extending out of a rear end of the insulative housing 100 from a rear end of the positioning portion 352 to connect with the cable 9. The coupling portions 351 correspond with the lenses 32 one by one. The floating recess 146 is wider than the slim slots 143 to receive all floating portions 355 therein. The floating portions 355 can slightly move in a small range along the transverse direction and the up to down direction when the base 30 moves. The positioning portions 352 are respectively received in the slim slots 143 and can not move along the transverse direction. Therefore, the positioning portions 352 can hold the base 30 to prevent the base 30 from moving overly along the transverse direction, then the lens 32 and fibers 35 can exactly mate with the mating connector along the front to back direction for assuring an effective optical signal transmission.

In addition, when the optical module 3 is assembled to the insulative housing 1, the cover 10 is positioned in the depression 144 to cover the floating recess 146 and the slim slots 143 for limiting the floating portions 355 and the positioning portions 352 of the fibers 35 from moving downwardly, which can hold the base 30 for preventing the base 30 from overly moving along the up to down direction.

The metal shell 7 comprises an upper shell 71 and a lower shell 72 engaging with the upper shell 71 to enclose the insulative housing 1. The upper shell 71 encloses the tongue 14 and has a bottom wall 711 resisting a lower surface of the tongue 14, a top wall 712 opposed to the bottom wall 711 and a pair of side walls 713 connecting the top wall 712 and bottom wall 711 along the up to down direction. The bottom wall 711 has a barb 75 protruding upwardly to resist the optical module 3.

When the optical connector 100 is inserted to the mating connector, the position holes 34 of the optical module 3 engage with the posts on the mating connector. When the posts have a length which is not consistent to a depth of the position holes 34, the optical module 3 can move along the front to back direction to compress or free the spring 4 for adjusting the engagement between the position holes 34 and the posts, which can flexibly connect with the mating connector; besides, the floating portions 355 are received in the floating recess 146 and can slightly move in a small range along the transverse direction and the up to down direction, while the positioning portions 352 of the fibers 35 are received in the slim slots 143 and are limited to move in the front to back direction, thereby the positioning portions 35 can hold the base 30 to prevent the base 30 from overly moving along the transverse direction; in addition, the spring 4 rings on the positioning posts 1421, 36 and can be adjusted to fit the movement of base 30; finally, the positioning portions 352 are limited by the insulative housing 1 and the cover 10 along the up to down direction, which can also hold the base 30 to prevent the base 30 from overly moving along the up to down direction.

When the optical connector 100 is withdrawn from the mating connector, the spring 4 rebounds to push the base 30 forwardly, then the limiting block 145 resists inner walls of the V-shaped indentation 31 to prevent the base 30 from overly moving along the front to back and the transverse direction. Besides, the lower side of the base 30 resists the barb 75 and the embosses 147 to prevent the base 30 from shaking along the up to down direction.

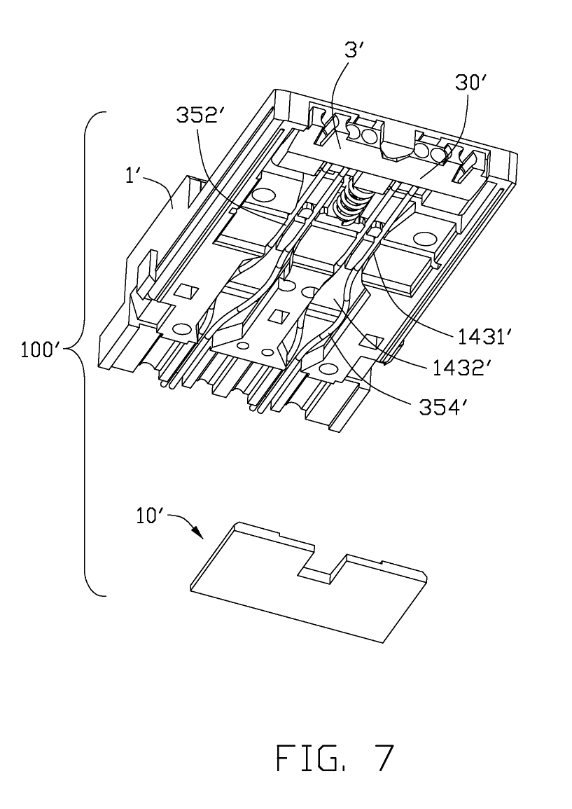

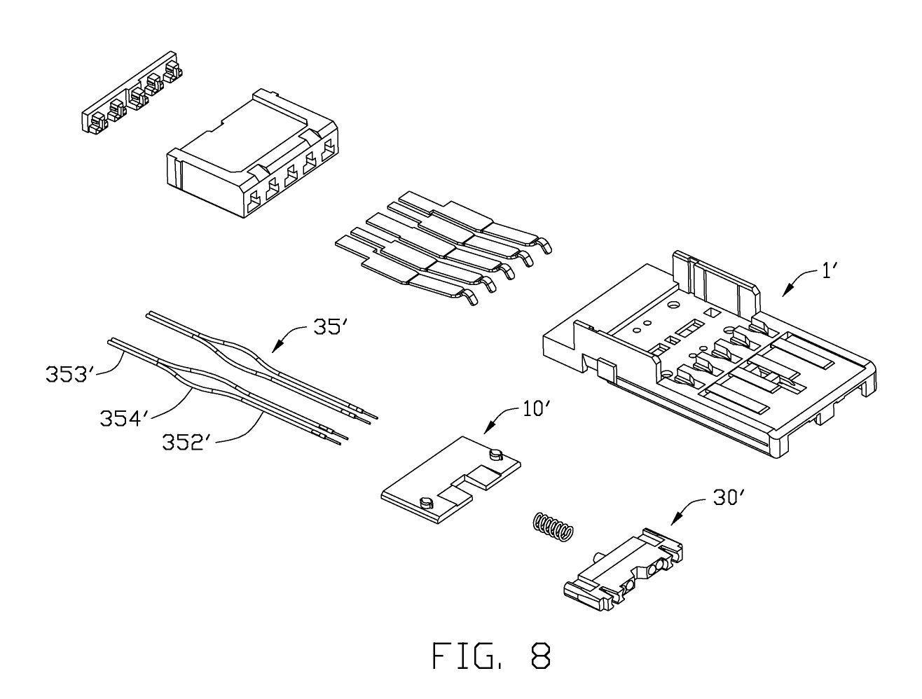

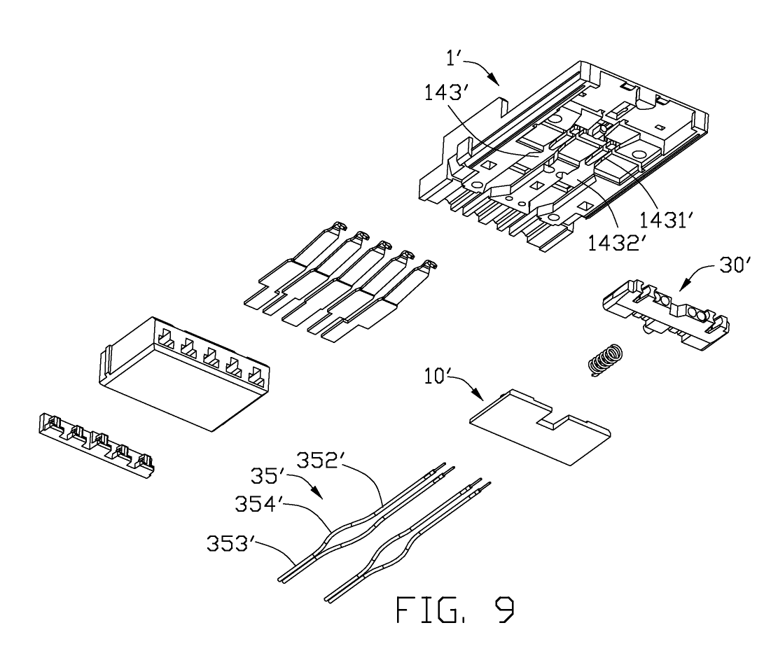

Referring to FIGS. 7-9, an optical connector 100′ according to a second embodiment is disclosed. The optical connectors 100, 100′ in the first and second embodiments are similar to each other, and have a small difference. The difference is that: each slot 143′ on the insulative housing 1′ not only comprises a slim first slot 1431′, but also comprises a wide second slot 1432′ behind the first slot 1431′ along the front to back direction; the first slot 1431′ and the second slot 1432′ communicate with each other along the front to back direction, and the second slot 1432′ is wider than the first slot 1431′ along the transverse direction; and each fiber 35′ of the optical module 3′ further has a bending portion 354′ between the positioning portion 352′ and the connecting portion 353′, and connecting the positioning portion 352′ and the connecting portion 353′ together along the front to back direction.

The positioning portions 352′ are positioned in the slim first slots 1431′ and limited by the cover 10′ for holding the base 30′ to prevent the base 30′ from overly moving along the transverse direction and the up to down direction. The bending portions 354′ of the fibers 35′ are received in the wide second slots 1432′. When the optical module 3′ is resisted backwardly, the positioning portions 1431′ can backwardly move into the wide second slots 1432′ and can bend in the second slots 1432′ along the transverse direction; besides, when the cable is pulled backwardly, the bending portions 354′ can extend straightly to eliminate a pulling force from the cable for preventing the fibers 35′ from being pulled to be damaged.

As fully described above, different embodiments of the present invention have been disclosed, but these are only some preferable embodiments used continually in fact, and such as a standard interface of POF connector, Module jack etc, can be stacked with a mating interface which is similar to the first mating interface in the first embodiment also for improving speed of signal transmission thereof, if it is necessary. All optical connectors described above have simple structure which is adapted to development trend of the electrical industry, and improve the speed of signal transmission thereof.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An optical connector, comprising:
an insultive housing having a top surface, a bottom surface, a cavity and a plurality of slim slots recessed from the bottom surface, the slim slots extending along a front to back direction and located behind the cavity;
an optical module disposed on the insulative housing, the optical module having a base received in the cavity and a plurality of fibers retained on the base and extending along a front to back direction; wherein
each fiber has a coupling portion retained in the base, a positioning portion behind the coupling portion, and a connecting portion backwardly extending out of the insulative housing, the positioning portions are respectively positioned in the slim slots for holding the base to prevent the base from overly moving along a transverse direction.

2. The optical connector according to claim 1, wherein the positioning portions can moves in the slim slots along the front to back direction.

3. The optical connector according to claim 2, wherein the insulative housing further defines a floating recess recessed from the bottom surface and located between the cavity and the slim slots, and each fiber has a floating portion between the coupling portion and the positioning portion, the floating portions are received in the floating recess and can slightly move in the floating recess along the transverse direction when the base moves.

4. The optical connector according to claim 3, wherein the floating recess forwardly communicates with the cavity and backwardly communicates with the slim slots, and the floating recess is wider than the slim slots to receive all floating portions of the fibers.

5. The optical connector according to claim 4, wherein the insulative housing defines a depression recessed from the bottom surface behind the cavity to receive a cover therein, said floating recess and said slim slots further recessed from a top inner wall of the depression respectively, and the cover covers a lower side of the floating recess and the slim slots to prevent the floating portions and the positioning portions from overly moving along an up to down direction.

6. The optical connector according to claim 2, wherein the base has a plurality of lenses at a front side thereof and a plurality of receiving holes behind the lenses to receive the coupling portions, the slim slots correspond with the receiving holes along the front to back direction respectively.

7. The optical connector according to claim 1, further comprising a spring sandwiched between the base and the insulative housing, the insulative housing has a first positioning post located behind the cavity and extending forwardly to position a rear end of the spring, and the base has a second positioning post backwardly extending toward the first positioning post to position a front end of the spring.

8. The optical connector according to claim 1, wherein the insulative housing further defines a plurality of wide slots recessed from the bottom surface and located behind the slim slots, and each fiber has a bending portion extending from a rear end of the positioning portion, and the bending portion is received in the wide slots.

9. The optical connector according to claim 8, wherein the wide slots forwardly communicate with the slim slots along the front to back direction, and are wider than the slim slots along the transverse direction.

10. An optical connector, comprising:
an insulative housing having a body portion and a tongue extending forwardly, the insulative housing defining a cavity recessed from a lower side of the tongue and a plurality of slim slots behind the cavity;
a plurality of contacts retained on the insulative housing, each contact having a contact portion forwardly extending to an upper side of the tongue; and
an optical module having a base movably received in the cavity and a plurality of fibers retained on the base, each fiber having a coupling portion retained in the base and a positioning portion backwardly extending out of the base to be positioned in the slim slots.

11. The optical connector according to claim 10, wherein the positioning portions are received in the slim slots and can move in the slim slots along a front to back direction.

12. The optical connector according to claim 11, wherein the insulative housing further defines a floating recess between the cavity and the slim slots, and each fiber has a floating portion between the coupling portion and the positioning portion, the floating portions are received in the floating recess and can slightly move in the floating recess along the transverse direction.

13. The optical connector according to claim 12, wherein the floating recess forwardly communicates with the cavity and backwardly communicates with the slim slots, and the floating recess is wider than the slim slots to receive all floating portions of the fibers.

14. The optical connector according to claim 10, wherein the insulative housing further defines a plurality of wide slots recessed from a lower side of the base and located behind the slim slots, and each fiber has a bending portion extending from a rear end of the positioning portion, and the bending portion is received in the wide slots.

15. The optical connector according to claim 10, wherein the contacts are USB 3.0 contacts to transmit USB 3.0 signals, and an arrangement of the contacts on the tongue is compatible to that of the USB 3.0 proposal.

16. A combo connector comprising:
an insulative housing defining an electrical mating face in a vertical direction and an optical mating face in a front-to-back direction perpendicular to said vertical direction, and further defining a cavity behind the optical mating face in said front-to-back direction;
a plurality of conductive contacts disposed in the housing with contacting sections exposed upon the electrical mating face; and
an optical module received in the cavity and back and forth moveable relative to the housing, said optical module including a base equipped with therein a plurality of lenses exposed upon the optical mating face, and further including a plurality of fibers located behind and linked to the corresponding lenses, respectively, a rear end of each of the fibers extending rearwardly out of the housing; wherein
each of said fibers defines a front section transversely snugly retained and is essentially allowed to move relative to the housing in said front-to-back direction for assuring precise alignment between the fiber and the corresponding lens while a middle section thereof extends in a curved loose manner for compromising buckling of the fiber when the base is moved to a rear position with regard to the housing during mating.

17. The combo connector as claimed in claim 16, wherein a rear section of each of said fibers is transversely restrained and essentially extends straight in the front-to-back direction.

18. The combo connector as claimed in claim 17, wherein said fiber are arranged with pairs, and each pair have the corresponding middle sections curved away from each other.

19. The combo connector as claimed in claim 18, wherein said each pair have the corresponding front sections respectively received in two separate slim slots while the corresponding rear sections are commonly received in the one slot.

20. The combo connector as claimed in claim 16, wherein both said front section and the rear section are restrained by the housing.
